(19) United States
(12) Patent Application Publication
(10) Pub. No.: US 2011/0189989 A1
(43) Pub. Date: Aug. 4, 2011

(54) Method and Apparatus for Cross Mode Mobility Optimization

(75) Inventor: Tomasz Mach, Hampshire (GB)

(73) Assignee: NOKIA CORPORATION, Espoo (FI)

(21) Appl. No.: 12/700,511

(22) Filed: Feb. 4, 2010

(51) Int. Cl. H04W 24/00; H04W 36/00

(52) U.S. Cl. 455/423; 455/436

(57) ABSTRACT

In accordance with an example embodiment of the present invention, an apparatus, comprising at least one processor; and at least one memory including computer program code, the at least one memory and the computer program code configured to, with the at least one processor, cause the apparatus to perform at least the following: determine an active mode measurement result; determine an idle mode measurement result; and estimate Active-Idle misalignment based at least in part on the active mode measurement result and the idle mode measurement result, is disclosed.

### TECHNICAL FIELD

The example embodiments of this invention relate generally to method and apparatus for cross mode mobility optimization.

### BACKGROUND

In currently deployed wireless networks, for example based on UTRAN (UMTS Terrestrial Radio Access Network) technology, an operator needs to put significant amount of effort to optimize its radio access network settings. This process is expensive and time consuming, and usually based on manual human control.

The network configuration complexity is increased in view of the number and structure of network parameters become large and complex, and the wireless network evolution happens quickly. Increasing network configuration complexity causes some trends for operators to automate or simplify the network optimization process.

Self-organizing networks (SON) is seen as a promising concept for operators to save operational expenditures. SON is currently discussed in 3GPP (third generation partnership project) standardization forum for LTE (long term evolution) standard and also in NGMN (next generation mobile network) Alliance.

The main functionality of SON comprises self-configuration, self-optimization and self-healing. Self-configuration is used to automatically install the necessary basic configuration for network operation. Self-optimization is used to auto tune the configuration data to optimize the network. In self-optimization process, measurement information from mobile stations and/or eNB may be utilized to optimize the network. Self-healing is used to automatically detect and resolve most faults.

Mobility management is required in a wireless communication network. It helps the network to track a mobile station and deliver services to the mobile station. In UTRAN/E-UTRAN (Evolved UMTS Terrestrial Radio Access Network), mobility management includes cell reselection and handover. The network is responsible for making handover decision for a mobile station that is in active mode, and the mobile station is responsible for triggering cell reselection when it is in idle mode. The network may broadcast some system parameters for idle mode mobile stations to control the cell reselection activity. The network may configure active mode mobile stations by explicit signaling to control the handover activity. Different set of parameters and rules may be configured by the network for handover and cell reselection.

### SUMMARY

Various aspects of examples of the invention are set out in the claims.

According to a first aspect of the present invention, an apparatus, comprising at least one processor; and at least one memory including computer program code, the at least one memory and the computer program code configured to, with the at least one processor, cause the apparatus to perform at least the following: determine an active mode measurement result; determine an idle mode measurement result; and estimate Active-Idle misalignment based at least in part on the active mode measurement result and the idle mode measurement result, is disclosed.

According to a second aspect of the present invention, a method, comprising determining an active mode measurement result; determining an idle mode measurement result; and estimating Active-Idle misalignment based at least in part on the active mode measurement result and the idle mode measurement result, is disclosed.

According to a third aspect of the present invention, a computer-readable medium bearing computer program code embodied therein for use with a computer, the computer program code comprising code for determining an active mode measurement result; code for determining an idle mode measurement result; and code for estimating Active-Idle misalignment based at least in part on the active mode measurement result and the idle mode measurement result, is disclosed.

### BRIEF DESCRIPTION OF THE DRAWINGS

For a more complete understanding of example embodiments of the present invention, reference is now made to the following description taken in connection with the accompanying drawings in which:

FIG. 1 shows a simplified block diagram of various electronic devices that are suitable for use in practicing example embodiments of the invention;

FIG. 2 is a flowchart of an example method for cross-mode mobility optimization according to an embodiment of the invention;

FIG. 3 is a flowchart of an example method for cross-mode mobility optimization according to another embodiment of the invention;

FIG. 4 shows a simplified block diagram of an embodiment of a network element that provides an environment for application of the example embodiments of this invention;

FIG. 5 shows a simplified block diagram of an embodiment of an user equipment that provides an environment for application of the example embodiments of this invention; and

FIG. 6 shows measurement curves when active-idle misaligned according to an embodiment of the invention.

### DETAILED DESCRIPTION OF THE DRAWINGS

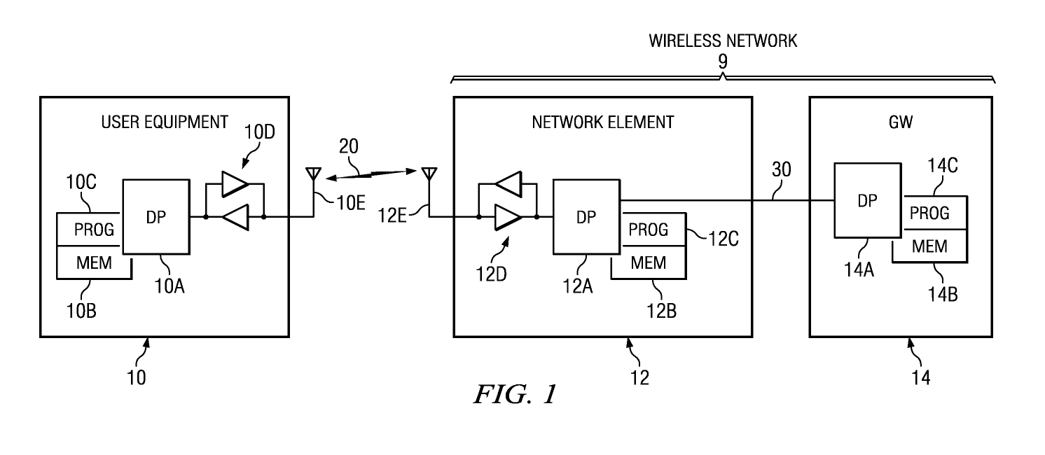

An example embodiment of the present invention and its potential advantages are understood by referring to FIGS. 1 through 6 of the drawings.

FIG. 1 shows a simplified block diagram of various electronic devices that are suitable for use in practicing example embodiments of the invention. In FIG. 1 a wireless network 9 is adapted for communication between an user equipment (UE) 10 and a network element 12. Network element 12 may be, for example, a wireless access node, such as a base station or particularly an e-NodeB for a LTE system and/or the like. The network 9 may comprise another network element 14, for example, a gateway GW, a serving mobility entity MME, a radio network controller RNC and/or the like.

In an embodiment, the user equipment 10 comprises a data processor (DP) 10A, a memory (MEM) 10B that stores a program (PROG) 10C, and a suitable radio frequency (RF) transceiver 10D coupled to one or more antennas 10E (one shown). Transceiver 10D and antenna 10E may be used for bidirectional wireless communications over one or more wireless links 20 with the network element 12.

The network element 12 also comprises a DP 12A, a MEM 12B that stores a PROG 12C, and a suitable RF transceiver 12D coupled to one or more antennas 12E (one shown). Antenna 12E may interface to the transceiver 12D via respective antenna ports. The network element 12 may be coupled via a data path 30 e.g., Iub or S1 interface, to the serving or other GW/MME/RNC 14. The GW/MME/RNC 14 may include a DP 14A, a MEM 14B that stores a PROG 14C, and a suitable modem and/or transceiver (not shown) for communication with the network element 12 over the data path 30.

The transceivers 10D, 12D may include both transmitter and receiver, and inherent in each is a modulator/demodulator commonly known as a modem. The DPs 12A, 14A also are assumed to each include a modem to facilitate communication over the (hardwire) link 30 between the network element 12 and the GW 14.

At least one of the PROGs 10C, 12C and 14C is assumed to comprise program instructions that, when executed by the associated DP, enable the electronic device to operate in accordance with the example embodiments of this invention, as described in further detail below. The PROGs may be embodied in software, firmware and/or hardware, as appropriate.

In general, the example embodiments of the invention may be implemented at least in part by computer software executable by the DPs 12A and 14A, or by hardware, or by a combination of software and hardware.

User equipment 10 may include, but are not limited to, mobile stations, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, GPS devices having wireless communication capabilities, Internet appliances permitting wireless Internet access and browsing, as well as portable units or terminals that incorporate combinations of such functions. Note that while a single UE 10 is shown in FIG. 1, in practice there will typically be at any given time some number of UEs 10 present in a cell or cells served by the network element 12.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory, removable memory, as non-limiting examples.

The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

In current UTRAN/E-UTRAN network, it is possible that a UE has different mobility behavior in active mode and idle mode. It is desirable to align the active mode handover and idle mode cell reselection in time-space domain. The UE stays in the same cell in idle mode and active mode for the same time and space condition. However, in practice they may not be aligned due to the fact that handover and cell reselection are triggered by different mechanisms and configured by different network parameters. As a result of the misalignment (active-idle misalignment), the UE may behave differently in terms of mobility even without a change in geographical location.

Here is an example to illustrate the active-idle misalignment. A UE stays in cell A when it is in idle mode. After the UE enters active mode, it moves to cell B, and stays in the cell B as long as the UE is in active mode. When the UE returns back to idle mode, it camps back to the cell A. In this situation, undesirable ping-pong handover and cell reselection between cell A and cell B can occur. From a network performance point of view, the ping-pong handover situation is not beneficial as it creates additional network signaling related to cell change.

When an UE is in active mode, the network is able to be aware of what happens in the UE by receiving measurement reports from the UE. For example, how strong the serving cell is, and/or any neighbour cell becomes stronger than the serving cell, etc. When an UE is in idle mode, measurement reporting is severely constrained on non-existent because the UE does not continuously transmit anything to the network in idle mode. The network is not able to be aware of what happens in the idle mode UE, though the UE is aware of what happens. Then, the network may have an information gap as to UE's idle mode situation. Lack of the UE's idle mode information is not beneficial to alleviate the possible active-idle misalignment, or to optimize network configurations such as mobility configuration and coverage configuration.

The example embodiments of this invention, as described in further detail below, provide cross-mode (active-idle) mobility optimization mechanisms to make the UE's idle mode information available to the network in order to facilitate the network optimization for active-idle alignment, and thus for mobility and coverage optimization. The example embodiments may be utilized by a self-organizing network (SON), but are not limited to only this one particular use.

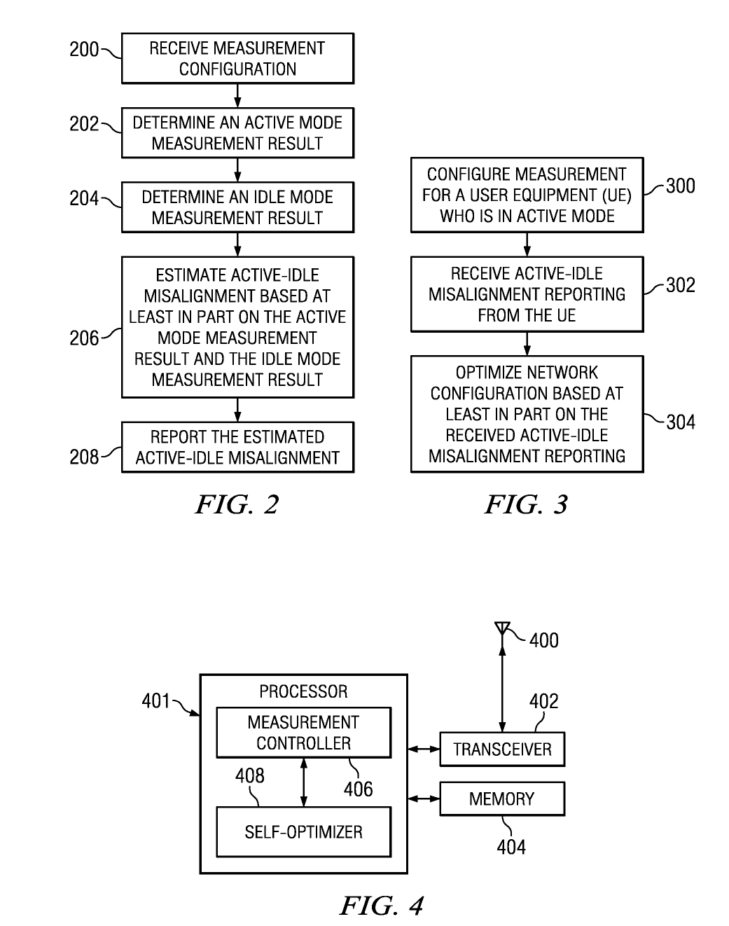

FIG. 2 is a flowchart of an example method for cross-mode mobility optimization according to an embodiment of the invention. In an example embodiment, the method of FIG. 2 is performed by user equipment (UE) that is in active mode, for example user equipment 10 of FIG. 1.

At block 200, the UE 10 receives a measurement configuration command. The measurement configuration command may include at least one cross-mode measurement control information element. The cross-mode measurement control information element instructs the active mode UE to report its idle mode information. In an example embodiment, the idle mode information comprises active-idle misalignment information.

In an example embodiment, the measurement configuration command is received from a network element, for example network element 12 of FIG. 1. In another example embodiment, the measurement configuration command is received in a Measurement Control message, for example by RRC (radio resource control) signaling. If desired, the measurement configuration command may be received in at least one physical layer message, or in at least one medium access control (MAC) message.

In an example embodiment, the cross-mode measurement control information element comprises an information element that can be referred to for convenience, and not as a limitation, as an Event Neighbor becomes offset better than serving information element.

At block 202, the UE 10 determines an active mode measurement result. The UE 10 makes a measurement, for example on reference signal receiving power (RSRP) and/or reference signal receiving quality (RSRQ), based at least in part on the measurement configuration command. In an example embodiment, the UE 10 makes active mode measurement every 10 ms. The UE 10 reports at least part of its measurement results to the network element 12 (e.g., to the Node B or eNB) if necessary. The UE may store some active mode measurement results for at least some period of time if desired.

In an example embodiment, the active mode measurement result relates to an event when cell handover is triggered. When the cell handover is triggered, the UE 10 stores the specific measurement result for the event of cell handover. From the stored one or more measurement results for the event of cell handover, the UE 10 determines the active mode measurement result. In an example embodiment, the active mode measurement result comprises at least one of a RSRP value and a RSRQ value. For simplity, the determined active mode measurement result can be referred to as an Active_handover hereafter.

At block 204, the UE 10 determines an idle mode measurement result. Though the UE is in active mode, it simulates an idle mode measurement that is done when the UE 10 is in idle mode. The UE 10 makes a measurement or measurements according to idle mode measurement requirements. The idle mode measurement requirements may be configured in the measurement configuration command received at block 200. Alternatively, the idle mode measurement requirements may be some saved parameters that were configured when the UE 10 was in idle mode. For example, the UE may perform an idle mode measurement every discontinuous reception (DRX) cycle (for example every 1280 ms).

The UE 10 makes the measurement, for example on reference signal receiving power (RSRP) and/or reference signal receiving quality (RSRQ), based at least in part on its idle mode measurement requirements. The UE 10 reports at least part of its measurement results to the network element 12 if necessary. The UE may store at least some idle mode measurement results for some period of time.

In an example embodiment, the idle mode measurement result relates to an event when cell reselection would be triggered. As the UE 10 is in active mode, no real (actual) cell reselection will be triggered. The UE 10 has the ability to judge when to trigger cell reselection. The UE 10 knows when cell reselection would be triggered in case it was in idle mode by observing its idle mode measurement results. When the cell reselection would be triggered, the UE stores the specific measurement result for the event of cell reselection. From the stored one or more measurement results for the event of cell reselection, the UE determines the idle mode measurement result. In an example embodiment, the idle mode measurement result comprises at least one of a RSRP value and a RSRQ value. For simplity, the determined idle mode measurement result can be referred to as an Idle_reselection hereafter.

At block 206, the UE 10 estimates if active-idle misalignment exists. In an example embodiment, the UE 10 compares the Active_handover and Idle_reselection to determine if active-idle misalignment is present. For example, the UE 10 may check the comparison by: Active_handover minus Idle_reselection. The comparison is not limited to subtraction, other mathematical calculations, for example division and logarithm, may also apply.

Consider the non-limiting example of Event Neighbour becomes offset better than serving measurement and minus comparison for illustration purposes. The UE 10 makes a measurement of a neighbour cell that becomes stronger than a serving cell, and the UE 10 derives Active_handover and Idle_reselection values. In an example embodiment, the Active_handover and Idle_reselection are RSRP or RSRQ values from the neighbour cell measurement.

Define for convenience: AI_difference=Active_handover−Idle_reselection. The AI_difference describes how large the misalignment in serving cell coverage is between active and idle mode. In case AI_difference is zero, no misalignment is present; otherwise, misalignment exists. In the case where AI_difference is positive, it induces cell reselection having a looser criterion to be triggered than handover. In the case where AI_difference is negative, it induces cell reselection having a stricter criterion to be triggered than handover. The larger the value of AI_difference, the higher is the possibility of active-idle misalignment. In an example embodiment, the criterion for triggering cell reselection or handover is a neighbour cell RSRQ threshold. In case the neighbour cell RSRQ threshold is met, the cell reselection or handover will be triggered. A looser criterion refers to a lower neighbour cell RSRQ threshold, a stricter criterion refers to a higher neighbour cell RSRQ threshold.

At block 208, the UE 10 reports (via the transceiver 10D) the estimated active-idle misalignment to the network element 12. In an example embodiment, the UE 10 sends an active-idle misalignment parameter to the network element 12. The active-idle misalignment parameter may be transmitted as part of a measurement report according to the measurement configuration command received at block 200. The active-idle misalignment parameter may be reported periodically, or the reporting may be event triggered. The UE 10 may report all or part of the AI_difference, Idle_reselection, Active_handover to the network element 12. Each of the AI_difference, Idle_reselection, Active_handover may relate to a RSRP value or a RSRQ value. Several reporting combinations can be used, and the example embodiments are not limited for use with any particular reporting combination or combinations. In general, the purpose and goal is to report to the network element 12 sufficient information to make it be aware of an occurrence of the active-idle misalignment.

In an example embodiment, when Event Neighbour becomes offset better than serving is configured, if the UE 10 has included RSRP_handover or RSRQ_handover in another part of a measurement report, the UE may include at least one of RSRQ_difference, RSRQ_reselection, RSRP_difference and RSRP_reselection in the active-idle misalignment parameter, wherein
RSRQ_difference=RSRQ_handover−RSRQ_reselection;
RSRP_difference=RSRP_handover−RSRP_reselection;
RSRQ_handover is the RSRQ value when cell handover is triggered;
RSRQ_reselection is the RSRQ value when cell reselection is triggered;
RSRP_handover is the RSRP value when cell handover is triggered; and
RSRP_reselection is the RSRP value when cell reselection is triggered.

FIG. 3 is a flowchart of an example method for cross-mode mobility optimization according to another embodiment of the invention. In an example embodiment, the method of FIG. 3 is performed by a network element, for example network element 12 of FIG. 1.

At block 300, the network element 12 configures the measurement for a user equipment (UE) 10 that is in active mode. In an example embodiment, the network element 12 may configure cross-mode measurement. The cross-mode measurement configuration orders the active mode UE to report its idle mode information such as active-idle misalignment information. The cross-mode measurement configuration may be conveyed by a cross-mode measurement configuration control information element. The cross-mode measurement configuration control information element may be included in a measurement configuration command, for example a Measurement Control message, to be transmitted to the UE 10.

In an example embodiment, the measurement configuration command is transmitted using RRC signaling. If desired, the measurement configuration command may be transmitted using at least one physical layer message, or in at least one medium access control (MAC) message.

In an example embodiment, the cross-mode measurement control information element comprises an Event Neighbour becomes offset better than serving information element. The Event Neighbour becomes offset better than serving information element is configured to comply with idle mode measurement requirement.

In an example embodiment, the Event Neighbour becomes offset better than serving information element (IE) comprises parameters of Time-to-trigger, Serving cell individual offset, and Neighbour cell individual offset. The Time-to-trigger parameter effects when to trigger a measurement report from the UE 10. After the conditions for the event, for example Neighbour becomes offset better than serving, have existed for the specified time given by time-to-trigger, the UE 10 reports the specific measurement report. The Serving cell individual offset is an offset to be added on the serving cell measurement result, the Neighbour cell individual offset is an offset to be added on the neighbour cell measurement result.

In a further example embodiment, the Time-to-trigger parameter is equal to Treselection, the serving cell individual offset parameter is equal to Qhyst, and the neighbour cell individual offset parameter is equal to Qoffset, wherein, Treselection specifies the cell reselection timer value, Qhyst specifies the hysteresis value for ranking criteria, and Qoffset specifies the offset between the serving cell and the neighbore cell.

At block 302, the network element 12 receives Active-Idle misalignment reporting from the UE 10. In an example embodiment, the Active-Idle misalignment reporting comprises all or part of AI_difference, Idle_reselection and Active_handover. Each of the AI_difference, Idle_reselection and Active_handover may relate to a RSRP value or a RSRQ value.

In the case where the Event Neighbour becomes offset better than serving is configured, the Active-Idle misalignment reporting comprises at least one of RSRP_handover, RSRP_reselection, RSRP_difference, RSRQ_handover, RSRQ_reselection, and RSRQ_difference.

At block 304, the network element 12 optimizes network configuration based at least in part on the received Active-Idle misalignment reporting. In an example embodiment, the network element 12 logs and analyses Active-Idle misalignment reporting from a plurality UEs. Based on the statistical analysis, the network element 12 is able to be aware of the non-optimized handover or reselection network configurations. In this case the network element 12 can adjust the handover or reselection network settings to alleviate or avoid Active-Idle misalignment.

FIG. 4 shows a simplified block diagram of an embodiment of a network element that provides an environment for application of the example embodiments of this invention. The network element may represent, without limitation, a base station, a Node B, or the like. For example, the network element could be network element 12 of FIG. 1. The block diagram may be embedded in the network element as a component of the network element.

The network element comprises antenna 400, processor 401, transceiver 402, and memory 404. The memory 404 is coupled to the processor 401 for storing programs and data of a temporary or more permanent nature. The transceiver 402 is coupled to the antenna 400 and to the processor 401 for bidirectional wireless communications, for example with the user equipment 10 of FIG. 1.

The processor 401 comprises a measurement controller 406, and a self-optimizer 408. The self-optimizer 408 is coupled to the measurement controller 406 for recognizing active-idle misalignment and optimizing network configurations.

The measurement controller 406 is configured to control the UE's measurement configurations and receive the measurement report(s). In an example embodiment, the measurement controller 406 may realize the block 300 and block 302 of FIG. 3. The self-optimizer 408 is configured to analyze the UEs' measurement reports, recognize active-idle misalignment, and optimize network configurations. In an example embodiment, the self-optimizer 408 may realize the block 304 of FIG. 3.

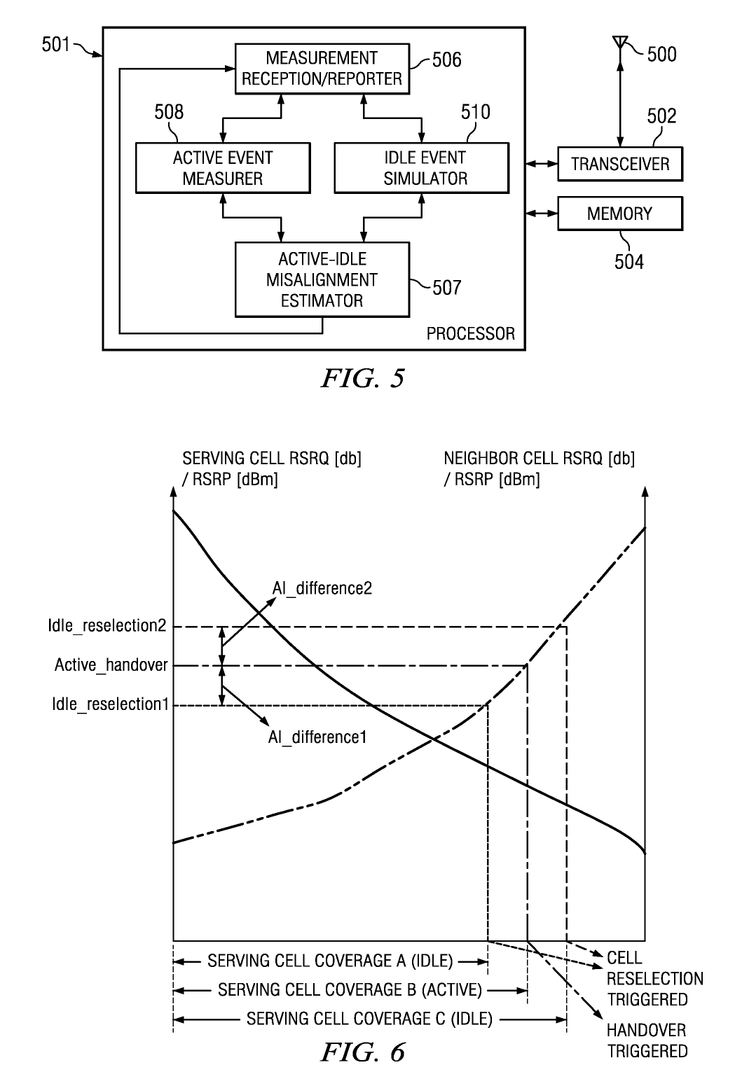

FIG. 5 shows a simplified block diagram of an embodiment of an user equipment that provides an environment for application of the example embodiments of this invention. For example, the user equipment could be user equipment 10 of FIG. 1. The block diagram may be embedded in the user equipment as a component of the user equipment.

The user equipment comprises antenna 500, processor 501, transceiver 502, and memory 504. The memory 504 is coupled to the processor 501 for storing programs and data of a temporary or more permanent nature. The transceiver 502 is coupled to the antenna 500 and to the processor 501 for bidirectional wireless communications, for example with the network element 12 of FIG. 1.

The processor 501 comprises a measurement reception/reporter 506, an Active-Idle misalignment estimator 507, an active event measure 508, and an idle event simulator 510. The active event measure 508 is coupled to the measurement reception/reporter 506 and the Active-Idle misalignment estimator 507. The idle event simulator 510 is coupled to the measurement reception/reporter 506 and the Active-Idle misalignment estimator 507. The Active-Idle misalignment estimator 507 is coupled to the measurement reception/reporter 506.

The measurement reception/reporter 506 is configured to receive measurement configuration commands and transmit measurement reports. It obtains inputs to be transmitted from the active event measure 508, the idle event simulator 510, and the active-idle misalignment estimator 507. In an example embodiment, the measurement reception/reporter 506 may realize the block 200 and block 208 of FIG. 2.

The active event measurer 508 is configured to measure an active mode event, for example the event when handover is triggered. The idle event simulator 510 is configured to simulate idle mode event, for example the event when cell reselection would be triggered.

The Active-Idle misalignment estimator 507 is configured to estimate whether active-idle misalignment exists based on the inputs provided by the active event measurer 508 and the idle event simulator 510. In an example embodiment, the Active-Idle misalignment 507 may realize the block 202, block 204 and block 26 of FIG. 2.

FIG. 6 shows measurement curves when there is an active-idle misaligned condition according to an embodiment of the invention. In FIG. 6, the horizontal axis represents cell coverage. The vertical axis represents measurement results of RSRQ in dB or RSRP in dBm. The left vertical axis represents the serving cell's measurement results. The right vertical axis represents the neighbour cell's measurement results. The solid line curve represents the serving cell's RSRQ/RSRP. The dotted-line curve represents neighbour cell's RSRP/RSRQ. The dashed line shows the measurement results when cell reselection would be triggered. The dash dotted line shows the measurement results when handover is triggered.

In the shown examples, Idle_reselection1 corresponds to serving cell coverage A for Idle mode, Active_handover corresponds to serving cell coverage B for active mode, and Idle_reselection2 corresponds to serving cell coverage C for idle mode. If Idle_reselection1 is smaller than Active_handover, AI_difference1 (Active_handover−Idle_reselection1) is positive, and induces that cell reselection has a lower RSRP/RSRQ threshold than handover. If Idle_reselection2 is greater than Active_handover, AI_difference2 (Active_handover−Idle_reselection2) is negative, and induces that cell reselection has a higher RSRP/RSRQ threshold than handover.

The measurement curves may be generated by the UE based on its measurement results. In an example embodiment, the UE may use the curves to judge if active-idle misalignment exists and determine how to report active-idle misalignment information to the network element to assist the self-optimizing functionality. If desired, the measurement curves may be generated by the network element based on the measurement reporting received from the UE. In an example embodiment, the network element may use the curves to identify active-idle misalignment, and thus perform self-optimizing to optimize network coverage and mobility.

Without in any way limiting the scope, interpretation, or application of the claims appearing below, a technical effect of one or more of the example embodiments disclosed herein is optimizing network coverage and mobility. Another technical effect of one or more of the example embodiments disclosed herein is alleviating active-idle misalignment. Another technical effect of one or more of the example embodiments disclosed herein is avoiding ping-pong handover and cell reselection.

Embodiments of the present invention may be implemented in software, hardware, application logic or a combination of software, hardware and application logic. The software, application logic and/or hardware may reside on user equipment, or network element. If desired, part of the software, application logic and/or hardware may reside on user equipment, part of the software, application logic and/or hardware may reside on network element. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (e.g., RSRP, RSRQ, etc.) are not intended to be limiting in any respect, as these parameters may be identified by any suitable names. Further, the formulas, expressions and mathematical operations that use these various parameters may differ from those expressly disclosed herein. Further, the various names assigned to different messages and/or information elements (e.g., “Event neighbor becomes offset better than serving”, “Active_handover”, “Idle_reselection”, etc.) are not intended to be limiting in any respect, as these various messages and/or information elements may be identified by any suitable names.

What is claimed is:

1. An apparatus, comprising:
at least one processor; and
at least one memory including computer program code
the at least one memory and the computer program code configured to, with the at least one processor, cause the apparatus to perform at least the following:
determine an active mode measurement result;
determine an idle mode measurement result; and
estimate Active-Idle misalignment based at least in part on the active mode measurement result and the idle mode measurement result.

2. The apparatus according to claim 1, wherein the active mode measurement result comprises a measurement result of an event when cell handover is triggered.

3. The apparatus according to claim 1, wherein the idle mode measurement result is determined by simulating an idle mode measurement during an active mode.

4. The apparatus according to claim 1, wherein the idle mode measurement result comprises a simulation result of an event when cell reselection is triggered.

5. The apparatus according to claim 1, wherein each of the active mode measurement result and the idle mode measurement result comprises at least one of a reference signal receiving power (RSRP) value and a reference signal receiving quality (RSRQ) value.

6. The apparatus according to claim 1, wherein the Active-Idle misalignment is estimated by a comparison between the active mode measurement result and the idle mode measurement result.

7. The apparatus according to claim 6, wherein the comparison is between the active mode measurement result and the idle mode measurement result on a neighbor cell that becomes stronger than a serving cell.

8. The apparatus according to claim 1, configured to further perform:
report an Active-Idle misalignment parameter based at least in part on the estimated Active-Idle misalignment.

9. The apparatus according to claim 8, wherein the Active-Idle misalignment parameter comprises at least one of RSRQ_difference, RSRQ_reselection, RSRQ_handover, RSRP_difference, RSRP_reselection and RSRP_handover, wherein
RSRQ_difference=RSRQ_handover−RSRQ_reselection;
RSRP_difference=RSRP_handover−RSRP_reselection;
RSRQ_handover is the RSRQ value when cell handover is triggered;
RSRQ_reselection is the RSRQ value when cell reselection is triggered;
RSRP_handover is the RSRP value when cell handover is triggered; and
RSRP_reselection is the RSRP value when cell reselection is triggered.

10. A computer-readable medium bearing computer program code embodied therein for use with a computer, the computer program code comprising:
code for determining an active mode measurement result;
code for determining an idle mode measurement result; and
code for estimating Active-Idle misalignment based at least in part on the active mode measurement result and the idle mode measurement result.

11. The computer computer-readable medium according to claim 10, further comprising:
code for reporting an Active-Idle misalignment parameter based at least in part on the estimated Active-Idle misalignment.

12. An apparatus, comprising:
at least one processor; and
at least one memory including computer program code
the at least one memory and the computer program code configured to, with the at least one processor, cause the apparatus to perform at least the following:
receive information on Active-Idle misalignment from at least one of a plurality of user equipments; and
optimize network configuration bases at least on the received information on Active-Idle misalignment.

13. The apparatus according to claim 12, configured to further perform:
configure an Active-Idle misalignment measurement event for an user equipment that is in active mode.

14. The apparatus according to claim 13, wherein the Active-Idle misalignment measurement event is configured based on idle mode requirements.

15. The apparatus according to claim 13, wherein the Active-Idle misalignment measurement event comprises Event Neighbor becomes offset better than serving.

16. A method, comprising:
determining an active mode measurement result;
determining an idle mode measurement result; and
estimating Active-Idle misalignment based at least in part on the active mode measurement result and the idle mode measurement result.

17. The method according to claim 16, wherein the determining an idle mode measurement result comprises simulating an idle mode measurement during an active mode.

18. The method according to claim 16, further comprising:
reporting an Active-Idle misalignment parameter based at least in part on the estimated Active-Idle misalignment.

19. A method, comprising:
receiving information on active-Idle misalignment from at least one of a plurality of user equipments; and
optimizing network configuration based at least on the received information on active-Idle misalignment.

20. The method according to claim 19, further comprising:
configuring an active-idle misalignment measurement event for an user equipment that is in active mode.
